(19) United States
(12) Patent Application Publication
(10) Pub. No.: US 2022/0204869 A1
(43) Pub. Date: Jun. 30, 2022

(54) PROCESS FOR PRE-HEATING REACTOR FEED STREAM

(71) Applicant: HALDOR TOPSØE A/S, Kgs. Lyngby (DK)

(72) Inventor: Lars JØRGENSEN, Greve (DK)

(73) Assignee: HALDOR TOPSØE A/S, Kgs. Lyngby (DK)

(21) Appl. No.: 17/610,824

(22) PCT Filed: Jun. 19, 2020
(86) PCT No.: PCT/EP2020/067191

§ 371 Date: Nov. 12, 2021

(30) Foreign Application Priority Data
Jun. 20, 2019 (DK) PA 2019 00753

(51) Int. Cl. C10G 45/04; C10G 69/06; C10G 31/08

(52) U.S. Cl. CPC C10G 45/04; C10G 2300/202; C10G 31/08; C10G 69/06

(57) ABSTRACT

A process plant and process for conversion of a hydrocarbonaceous feed, having a feed temperature, to a hydrocarbonaceous effluent, having an effluent temperature, by hydrotreatment, in the presence of a material catalytically active in hydrotreatment and an amount of hydrogen, wherein the conversion is exothermal and wherein an amount of the effluent will solidify at a solidification temperature above the feed temperature and below the effluent temperature, and wherein the feed is preheated by heat exchange, utilizing thermal energy from said effluent, wherein the heat exchange is mediated by a fluid heat exchange medium being physically separated from the feed and the effluent and having a temperature above the solidification temperature, with the associated benefit of such a process being highly energy effective, while avoiding solidification in the process lines, especially when hydrotreating feedstocks including halides.

### FIELD OF THE INVENTION

This invention relates to a process and a system for conversion of a hydrocarbonaceous feed wherein an amount of the converted feed may solidify, and specifically a process and a system for removing halides from a hydrocarbon stream comprising one or more halides.

### BACKGROUND OF THE INVENTION

Refinery and petrochemical processes comprise a plurality of treatments of hydrocarbon rich streams in order to provide products or intermediates in the form of naphtha, gasoline, diesel, etc. Such treatments comprise hydro-treatment, hydro-cracking, steam-cracking, fractionation and stripping, as well as intermediate heat exchange and removal of impurities.

Some of the hydrocarbon rich streams to be processed in the refinery comprises halides, e.g. comprising chlorine. Halides are unwanted in the product(s) and are also disadvantageous within the refinery plant due to corrosion and pressure drop issues within the units of the plant.

In addition to halides, other heteroatoms are also present in the treated hydrocarbons, e.g. nitrogen. During hydrotreatment organically bound nitrogen is converted to ammonia. Ammonia and halides may react to form salts, e.g. ammonium chloride, which is a solid at temperatures below the precipitation temperature typically 150° C. to 300° C. Precipitation of such salts may result in partial or complete blocking of process lines as well as potential corrosion and must therefore be avoided. Therefore, it is important to ensure the process temperature to be above the precipitation temperature.

Typically, the hydrotreatment reactions are exothermal, and therefore it is possible to optimize the energy consumption of the process, by heat exchange between feed and effluent. If ammonia and halides are present a problem in this respect is however that in a feed/effluent heat exchanger, temperatures may be below the precipitation temperature and may result in cold zones in the heat exchanger, where e.g. ammonium chloride may precipitate.

According to the present invention it has now been identified that by recuperating the thermal energy of the effluent in a hot stream of heat exchange medium, the operation of a hydrotreatment process for removal of organically bound halides and nitrogen will be robust. Such a hot stream may be a heat transfer oil, i.e. a liquid oil in a heat exchange circuit or a boiling liquid, typically water, in a pressurized boiler.

WO 2015/050635 relates to a process for hydrotreating and removing halides from a hydrocarbon stream by hydrotreatment. The document is silent on the presence of nitrogen in the reactor effluent stream, and contrary to the present disclosure it explicitly recommends recuperation of heat from the hydrotreated product by heat exchange with chilled water, which is highly likely to cause precipitation of salts, if nitrogen was present.

### BRIEF SUMMARY OF THE INVENTION

A broad aspect of the present disclosure relates to a process for conversion of a hydrocarbonaceous feed, having a feed temperature, to a hydrocarbonaceous effluent, having an effluent temperature, by hydrotreatment, in the presence of a material catalytically active in hydrotreatment and an amount of hydrogen,

wherein said conversion is exothermal and wherein an amount of said effluent will solidify at a solidification temperature above said feed temperature and below said effluent temperature,

and wherein said feed is preheated by heat exchange, utilizing thermal energy from said effluent,

characterized in said heat exchange being mediated by a fluid heat exchange medium being physically separated from said feed and said effluent and having a temperature above said solidification temperature,

with the associated benefit of such a process being highly energy effective, while avoiding solidification in the process lines when hydrotreating feedstocks comprising halides, such as waste plastic or the product from thermal decomposition of waste plastic, other products of thermal decomposition processes, as well as fossil feedstock comprising halides, including kerogenic feeds such as coke oven tar, coal tar or shale oil.

In a further embodiment said heat exchange medium is a vapor generated from a liquid when heated by said effluent in a boiler, with the associated benefit of a boiler providing a stable temperature defined by the pressure of the liquid.

In a further embodiment said heat exchange medium is a liquid at the temperature of said effluent with the associated benefit of a liquid heat exchange medium being simpler to handle than a boiling liquid.

In a further embodiment said hydrocarbonaceous feed comprises one or more organically bound halides and organically bound nitrogen and said material catalytically active in hydrotreatment is active in converting organically bound halides and organically bound nitrogen into inorganic halides and ammonia, with the associated benefit of such a process avoiding the risk of solidification of ammonium-halides due to cold spots in the heat exchange circuits.

In a further embodiment said effluent is separated into a first vapor phase and a first liquid phase in a separator unit, and inorganic halides are removed from said first vapor phase by contact with an amount of water, with the associated benefit of providing an intermediate product free of halides.

In a further embodiment the one or more halides comprise chloride, with the associated benefit of such a process being suited to purify e.g. thermal decomposition products of chloride containing plastic waste or salt containing biological material.

In a further embodiment the material catalytically active in converting organically bound halides into inorganic halides is also catalytically active in olefin saturation, with the associated benefit of such a material being able to provide a simpler process for treating olefinic feedstocks, such as waste plastic or products from thermal decomposition of waste plastic, comprising e.g. PVC, other products of thermal decomposition or hydrothermal liquefication processes, kerogenic feeds such as coal tar or shale oil, as well as feed originating from algae lipids, especially when grown in salt water, or other biological feeds comprising hydrocarbons and chloride.

In a further embodiment the material catalytically active in converting organically bound halides into inorganic halides comprises: (i) a group VIII metal, (ii) a group VIB metal, and (iii) a support, said support comprising one or more of the following: aluminum oxide, silicium oxide, and titanium oxide, with the associated benefit of such materials being cost effective catalysts for hydroprocessing. The catalytic material could e.g. be a nickel molybdenum catalyst on a support or a cobalt-molybdenum catalyst on a support.

In a further embodiment the process is followed by the step of:

further treating the first liquid phase from said separator unit in order to provide a hydrocarbon product, with the associated benefit of such a product being suited for use as a transportation fuel or as an intermediate raw material in chemical processes. Such further treatment may e.g. be hydro-treating, for example including distilling, fractionation, and/or stripping.

In a further embodiment the process is followed by the step of directing the hydrocarbon product to a steam-cracking process, with the associated benefit of providing raw material for petrochemical processes, from e.g. waste products, biological material or low cost resources.

A further aspect of the disclosure relates to a system for hydrotreatment of a hydrocarbon stream comprising
(a) a hydroprocessing reactor containing a material catalytically active in hydroprocessing, said hydroprocessing reactor comprising an inlet for inletting a hydrogen enriched hydrocarbon stream and an outlet for outletting a first product stream,
(b) a feed heat exchanger upstream said hydroprocessing reactor and an effluent heat exchange downstream said hydroprocessing reactor, being in thermal communication via a heat exchange medium

with the associated benefit of such a system being well suited for treating processes where there is a risk of solidification of the products.

A system according to claim 11 wherein said effluent heat exchanger is a boiler, with the associated benefit of a boiler providing a stable temperature defined by the pressure of the liquid.

From 30% or 80% to 90% or 100% of the organic halides in a hydrocarbonaceous feedstock, may be converted to inorganic halides in a hydrocarbon product stream by one embodiment of the disclosure. A similar amount of organic nitrogen is converted to ammonia by one embodiment of the disclosure. The hydrocarbon product is washed with water which binds inorganic halides and ammonia and is separated from the hydrocarbon stream is separated from the hydrocarbon stream. To save energy, it is beneficial to use the heat of the effluent to pre-heat the feed, but inorganic halides and ammonia may react and precipitate as e.g. ammonium chloride if the temperature is too low. A normal feed/effluent heat exchanger may have cool spots where such precipitation may occur, and therefore cooling must be carried in a way avoiding this negative effect.

By the wash with water, the inorganic halides from the hydrocarbon stream are removed from the product. These inorganic halides removed from the hydrocarbon stream are taken away from the system, e.g. by regenerating the wash water by evaporation.

The process of the invention may advantageously be a part of a process for treating a hydrocarbon stream.

In an embodiment, a make-up hydrogen stream is added to the hydrogen rich gas phase prior to the recycling into the hydroprocessing reactor. This is in order to ensure the required hydrogen to be present within the hydroprocessing reactor for the conversion of organic halides into inorganic halides, and possibly also further reactions, such as olefin saturation.

Throughout this text, the term “a material catalytically active in converting organic halides into inorganic halides” is meant to denote catalyst material arranged for and/or suitable for catalyzing the conversion. “Organic halides” are chemical compounds in which one or more carbon atoms are linked by covalent bonds with one or more halogen atoms (fluorine, chlorine, bromine, iodine or astatine—group 17 in current IUPAC terminology). “Inorganic halides” are chemical compounds between a halogen atom and an element or radical that is less electronegative (or more electropositive) than the halogen, to make a fluoride, chloride, bromide, iodide, or astatide compound, with the further limitation that carbon is not part of the compound. A typical example of a material catalytically active would be classical refinery hydrotreatment catalyst, such as one or more sulfide base metals on a refractive support.

The term “removing halides” is meant to include situations where either some of the halides present or all of the halides present are converted into inorganic halides, and subsequently removed. The term is thus not limited to situation where a certain percentage of the halides present are removed.

The term “letting the stream react at the presence of the catalytically active material” is meant to cover bringing the stream into contact with the catalytically active material under conditions relevant for catalysis to take place. Such conditions typically relate to temperature, pressure and stream composition.

The term “thermal decomposition” shall for convenience be used broadly for any decomposition process, in which a material is partially decomposed at elevated temperature (typically 250° C. to 800° C. or perhaps 1000° C.), in the presence of substoichiometric amount of oxygen (including no oxygen). The product will typically be a combined liquid and gaseous stream, as well as an amount of solid char. The term shall be construed to included processes known as pyrolysis, hydrothermal liquefaction, and partial combustion.

The process and the system disclosed may be found useful where the feed to a hydrotreatment process comprises halides and especially where the temperature must be kept moderate, e.g. to avoid side reactions of olefins and diolefins. Examples of such processes include direct hydrotreatment of waste plastic or hydrotreatment of the product from thermal decomposition halide rich materials, such as of waste plastic, comprising e.g. PVC or other halide containing plastics as well as of biological materials with high halide content, e.g. straw and algae, as well as other products of thermal decomposition and kerogenic feeds such as coal tar or shale oil. The feed may also originate from non-pyrolysed renewable feedstocks, e.g. algae lipids, especially when grown in salt water, or other biological feeds comprising hydrocarbons and chloride.

Ammonia and halides react to form salts, e.g. ammonium chloride, at temperatures below the precipitation temperature typically 150° C. to 300° C. Precipitation of such salts may result in partial or complete or partial blocking of process lines as well as potential corrosion, and must therefore be avoided. Therefore, it is important to ensure the process temperature to be above the precipitation temperature which will depend on the process conditions.

The product of the process may be directed to further treatment, either for the production of hydrocarbon transportation fuel of for petrochemical processes, i.e. in a steamcracker.

### BRIEF DESCRIPTION OF THE FIGURE

FIG. 1 discloses a system for treating a hydrocarbon stream.

### DETAILED DESCRIPTION OF THE FIGURE

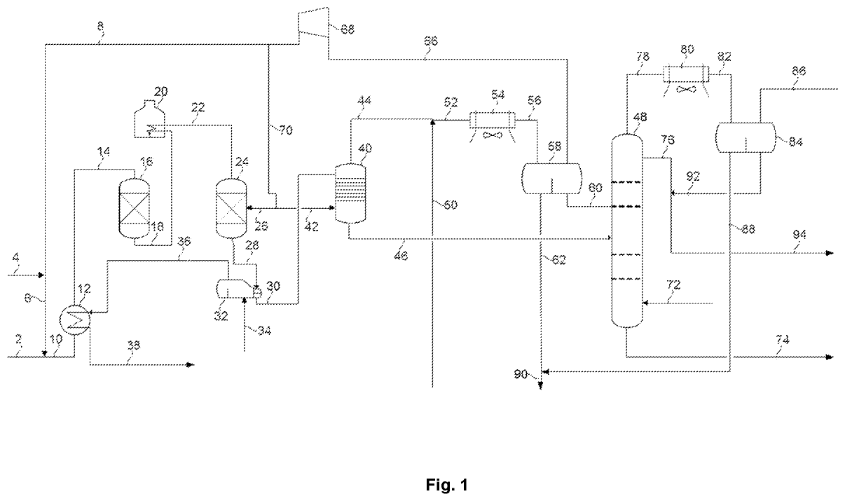

FIG. 1 discloses a system for treating hydrocarbons. Even though some heat exchange units, pumps and compressors are shown in FIG. 1, further pumps, heaters, valves and other process equipment may be part of the system of FIG. 1.

The system of FIG. 1 comprises a sub-system for removing halides from a hydrocarbon stream before the hydrocarbon stream enters a stripper and/or fractionation section.

FIG. 1 shows a hydrocarbon stream 2 containing chlorine. This stream is optionally preheated, before being combined with a hydrogen rich gas stream 6 to a hydrogen enriched hydrocarbon stream 10 in order to ensure the provision of the required hydrogen for the hydrogenation of di-olefins. The hydrogen enriched hydrocarbon stream 10 is heated by heat exchange with a heat exchange medium 36 in heat exchanger 12, and optionally by further heating such as a fired heater to form a heated hydrogen enriched hydrocarbon stream 14. The first reactor 16 is optional, but may have operating conditions at a pressure of about 30 Barg and a temperature of about 180° C., suitable for hydrogenation of di-olefins. The first reactor 16 contains a material catalytically active in olefin saturation and hydro-dehalogenation. Within the first reactor 16, the heated hydrogen enriched hydrocarbon stream 14 reacts at the presence of the catalytically active material, rendering a first hydrogenated product stream 18.

The first hydrogenated product stream 18 is heated, e.g. in a fired heater 20, and transferred as a heated first hydrogenated product stream 22 to a second reactor 24 where it reacts at the presence of a second catalytically active material. Often quench gas 26 is provided to the second reactor to control the temperature. The first and second catalytically active material may be identical or different from each other and will typically comprise a combination of sulfided base metals such as molybdenum or tungsten promoted by nickel or cobalt supported on a refractory support such as alumina or silica. Typically, the reaction over the first catalytically active material is dominated by saturation of di-olefins, whereas the reaction over the second catalytically active material is dominated by saturation of mono-olefins and hydro-dehalogenation of halide-hydrocarbons, but also hydrodesulfurization, hydrodenitrogenation and hydrodeoxygenation may take place in the second reactor 24 (depending on the composition of the feedstock). Therefore, the hot product stream 28 may comprise hydrocarbons, H₂O, H₂S, NH₃ and HCl, which may be withdrawn by washing and separation. However, NH₃ and HCl may react to form NH₄Cl, which under some conditions may condense at high temperatures, e.g. around 270° C. To provide an energy efficient process the hot product stream 28 is cooled to form a cooled product stream 30, by heat exchange with the hydrogen enriched hydrocarbon stream 10 via a heat exchange circuit comprising in a boiler 32, which receives boiler feed water 34 and produces steam 36, which is directed to heat the hydrogen enriched hydrocarbon stream 10 in heat exchanger 12. By providing a separate steam circuit for the heat exchange, it may be ensured that e.g. a 90° C. hydrogen enriched hydrocarbon stream 10 does not provoke cold spots in the heat exchange with the hot product stream 28. As the heat exchange is made in a boiler 32, the thermal stability is further ensured, since the temperature of a boiler is highly stable, as an amount of hot liquid water and steam are in equilibrium at the temperature defined by the boiler pressure. Therefore, the risk of having cold spots on the hot side of the thermal circuit is minimal, and thus precipitation of NH₄Cl is avoided. The cooled product stream 30 is directed to a hot stripper 40 where separation is aided by a stripping medium 42, in which the cooled product stream 30 is split in a gas product fraction 44 and a liquid product fraction 46. The gas product fraction 44 is combined with a stream of water 50, providing a mixed stream 52 and cooled in cooler 54, providing a three phase stream 56, which is separated in three-way separator 58, into a light hydrocarbon stream 60, a contaminated water stream 62 and a hydrogen rich recycle gas stream 66. The hydrogen rich recycle gas stream 66 is directed to a recycle compressor 68, and directed as quench gas 26 for the second reactor 24 and as stripping medium 42 for the hot stripper 40, as well as recycle gas 8 to be combined with makeup hydrogen gas 4, forming hydrogen rich gas stream 6.

The light hydrocarbon stream 60 exiting the three-way separator 58 enters a second stripper 48 to further separate liquid and gaseous components, with the aid of a stripping medium 72. The light ends output 78 from the second stripper 48 is cooled in cooler 80 and directed as a cooled light ends fraction 82 to a further three-phase separator 84 arranged to separate an off-gas fraction 86 from a water fraction 88 and a hydrocarbon liquid fraction 92. The hydrocarbon liquid fraction 92 from the further three-phase separator 84 is recycled to the second stripper 48, the water fraction 88 can be combined with the contaminated water stream 62 and removed as sour water 90 and the gaseous fraction is removed as off-gas fraction 86. A light hydrocarbon stream 94 may be withdrawn. Liquid hydrocarbon product 74 is withdrawn from the stripper.

In an alternative embodiment the boiler based heat exchange circuit may be replaced with a circuit employing another type of heat exchange medium such as a heat transfer oil.

1. A process for conversion of a hydrocarbonaceous feed, having a feed temperature, to a hydrocarbonaceous effluent, having an effluent temperature, by hydrotreatment, in presence of a material catalytically active in hydrotreatment and an amount of hydrogen,
wherein said conversion is exothermal and wherein an amount of said hydrocarbonaceous effluent will solidify at a solidification temperature above said feed temperature and below said effluent temperature,
and wherein said feed is preheated by heat exchange, utilizing thermal energy from said effluent,
wherein said heat exchange is mediated by a fluid heat exchange medium being physically separated from said feed and said effluent and having a temperature above said solidification temperature.

2. A process according to claim 1, wherein said fluid heat exchange medium is a vapor generated from a liquid when heated by said effluent in a boiler.

3. A process according to claim 1, wherein said heat exchange medium is a liquid at the temperature of said hydrocarbonaceous effluent.

4. A process according to claim 1, wherein said hydrocarbonaceous feed comprises one or more organically bound halides and organically bound nitrogen and said material catalytically active in hydrotreatment is active in converting organically bound halides and organically bound nitrogen into inorganic halides and ammonia.

5. A process according to claim 4, wherein said effluent is separated into a first vapor phase and a first liquid phase in a separator unit, and inorganic halides are removed from said first vapor phase by contact with an amount of water.

6. A process according to claim 4, wherein the one or more halides comprise chloride.

7. A process according to claim 4, wherein the material catalytically active in converting organically bound halides into inorganic halides is also catalytically active in olefin saturation.

8. A process according to claim 4, wherein the material catalytically active in converting organically bound halides into inorganic halides comprises: (i) a group VIII metal, (ii) a group VIB metal, and (iii) a support, said support comprising one or more of the following: aluminum oxide, silicium oxide, and titanium oxide.

9. A process for hydro-treating a hydrocarbon stream comprising the process of claim 5, followed by the step of:
further treating the first liquid phase from said separator unit in order to provide a hydrocarbon product.

10. A process according to claim 9, followed by the step of directing the hydrocarbon product to a steam-cracking process.

11. A system for hydrotreatment of a hydrocarbon stream comprising
(a) a hydroprocessing reactor containing a material catalytically active in hydroprocessing, said hydroprocessing reactor comprising an inlet for inletting a hydrogen enriched hydrocarbon stream and an outlet for outletting a first product stream,
(b) a feed heat exchanger upstream said hydroprocessing reactor and an effluent heat exchanger downstream said hydroprocessing reactor, being in thermal communication via a heat exchange medium.

12. A system according to claim 11 wherein said effluent heat exchanger is a boiler.
